(19) United States
(12) Patent Application Publication
(10) Pub. No.: US 2008/0235132 A1
(43) Pub. Date: Sep. 25, 2008

(54) Transactional Device With Anticipated Pretreatment

(75) Inventors: Michel Banatre, La Fresnais (FR); Paul Couderc, Rennes (FR); Mathieu Becus, Vitre (FR)

Correspondence Address: FOLEY AND LARDNER LLP;SUITE 500, 3000 K STREET NW, WASHINGTON, DC, 20007, US

(73) Assignee: Inria Institut National De Recherche En Informatique Et En Automatique, Le Chesnay Cedex (FR)

(21) Appl. No.: 10/585,973

(22) PCT Filed: Jan. 14, 2005
(86) PCT No.: PCT/FR2005/000088

§ 371 Date: Jun. 13, 2008

(30) Foreign Application Priority Data
Jan. 15, 2004 (FR) 0400352

(51) Int. Cl. G06Q 40/00; H04B 7/00

(52) U.S. Cl. 705/39; 455/41.2

(57) ABSTRACT

The invention concerns a transactional device comprising a station (2) capable of performing a transaction, and an equipment (32), for setting up a wireless communication network, with one or more mobile terminals (34), based on a connection protocol, as well as a communication with said station (2). The equipment (32) is configured with a perimeter (36) selected to cover a specific zone, proximate to said station (2), while the connecting protocol is configured to enable initial identity information transmitted by a mobile terminal present in said zone to be exchanged against a unique temporary code, such exchange being followed by launching of a background function enabling part at least of a transaction to be prepared based on said identity information, and so that the station (2) is capable, upon presentation of the unique temporary code, of recovering then completing, if required, and validating the transaction.

The invention relates to transaction devices which are at least partly automated and more particularly to those where the transaction is completed by the delivery of a service.

These devices are becoming more and more widely used and deliver a variety of services.

For example, different types of automatic cash dispensers are known, which manage a transaction between a user equipped with a credit card and a banking network and which is completed by the delivery of a sum of money by way of a service.

Likewise, check-outs are known which are installed in shops and which carry out a transaction between the customer and the shop, which ends with making of the actual payment.

These devices have consequent advantages, such as the permanent issue of cash or the validation of a purchase solely for clients having the necessary sum of money, as regards both the examples considered.

However, these devices are rapidly obstructed when plural users present themselves. On the other hand, the time spent by a user in front of the device is often long compared to the delivery of the service itself.

The object of the invention is to reduce the time spent by a user in front of the aforesaid devices in order to obtain a service by proposing a transaction device of a new type.

In general, systems are known comprising a station capable of carrying out a transaction, and an apparatus capable of setting up a wireless communication network with one or more mobile terminals, based on a connection protocol, as well as a communication with the station.

The device according to the invention starts out from such a system used to carry out a transaction and further provides that the apparatus is contrived with a perimeter selected to cover a determined zone, close to the station, whereas the connection protocol is contrived to allow the initial exchange of identity information transmitted by a mobile terminal present in this zone against a unique temporary code, such exchange being followed by the launch of a background function allowing the preparation of at least part of a transaction on the basis of the said identity information, and that the station is capable, upon presentation of the unique temporary code, of recovering then completing as required and validating the transaction.

Thus the device according to the invention makes it possible to process part of the transaction without the physical presence of the user in front of the station, also reducing the time spent by the user in front of the station. Only the presence of the user within the selected perimeter is required to initiate the preparation of the transaction.

Further features and advantages of the invention will appear from a study of the detailed description given below, as well as from the attached drawings, which show:

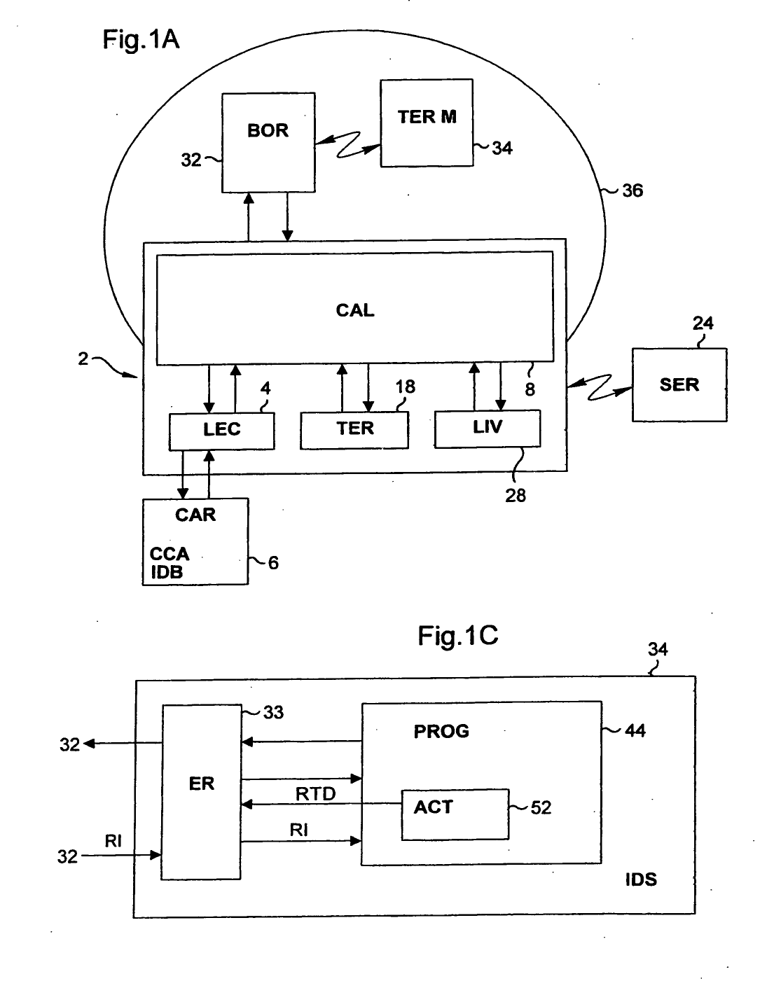

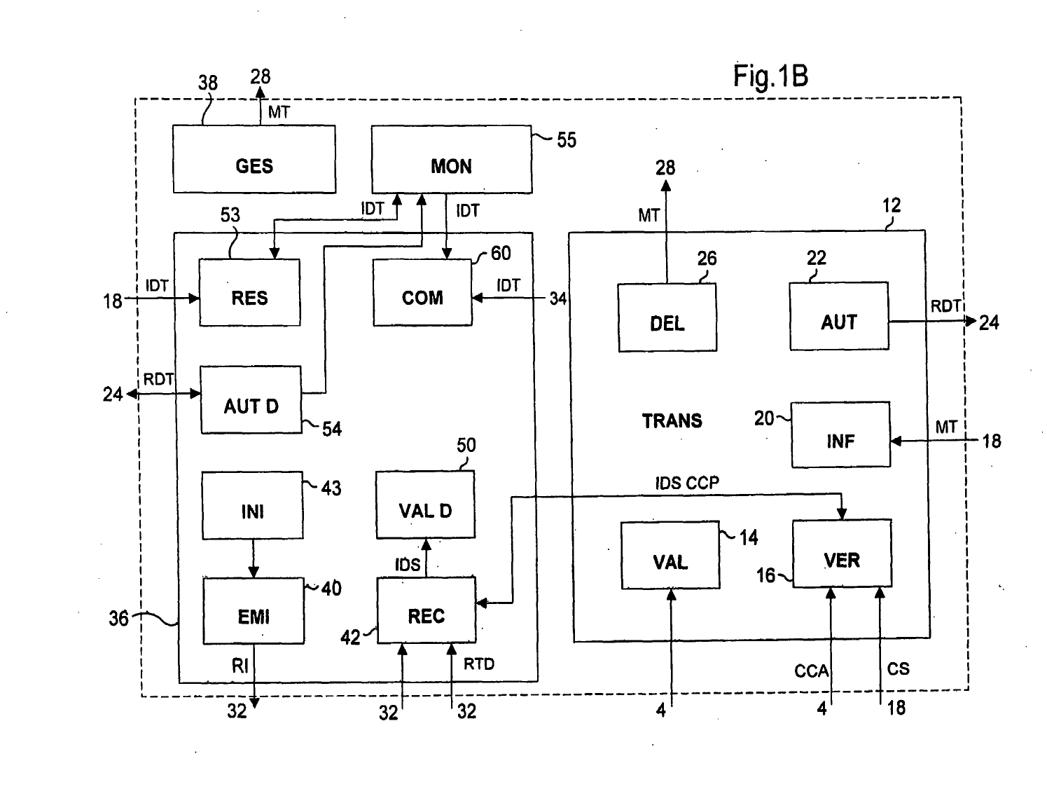

FIGS. 1A, 1B and 1C are diagrams illustrating the device according to the invention in a first embodiment,

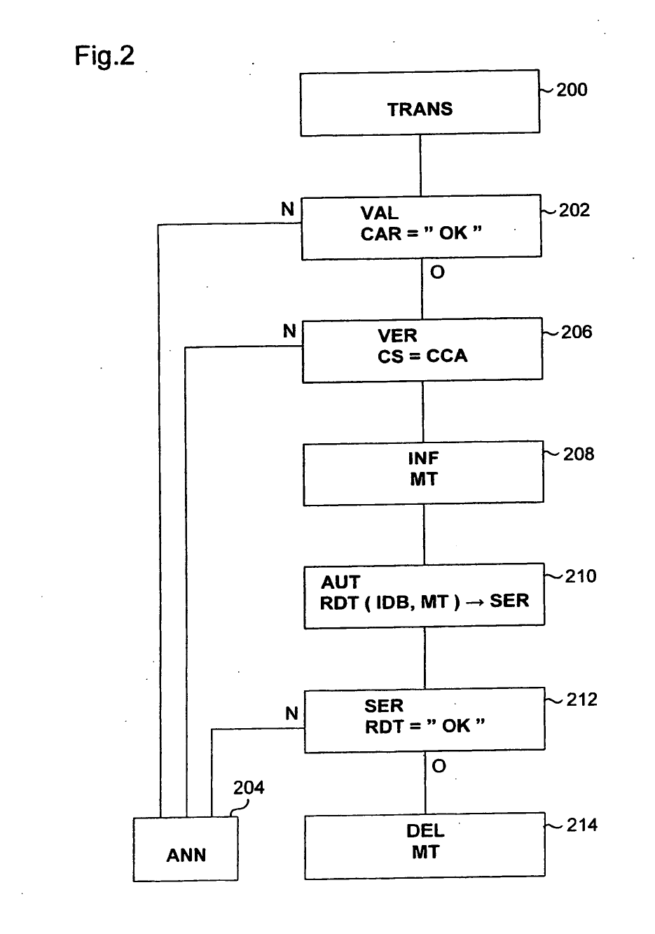

FIG. 2 is a flow-chart illustrating the function of the device of FIG. 1 according to a first method of use,

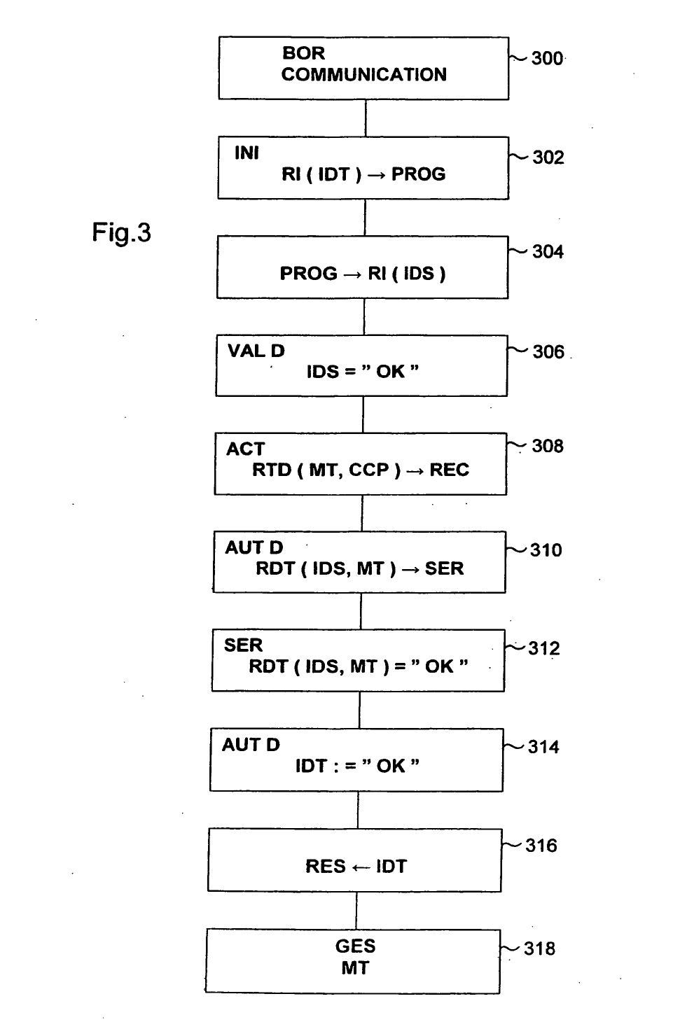

FIG. 3 is a flow-chart illustrating the function of the device of FIG. 1 according to an advantageous method of use,

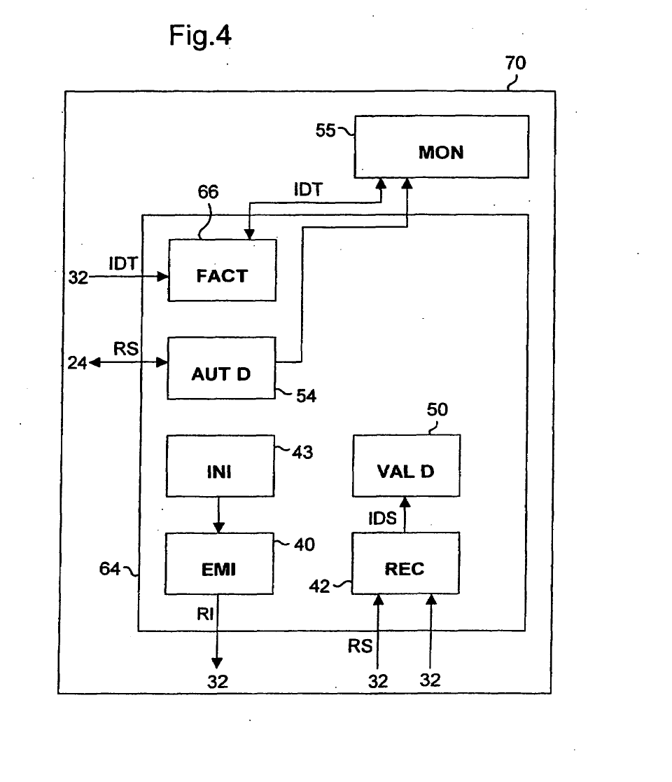

FIG. 4 is a diagram illustrating the device according to the invention in a second embodiment, and

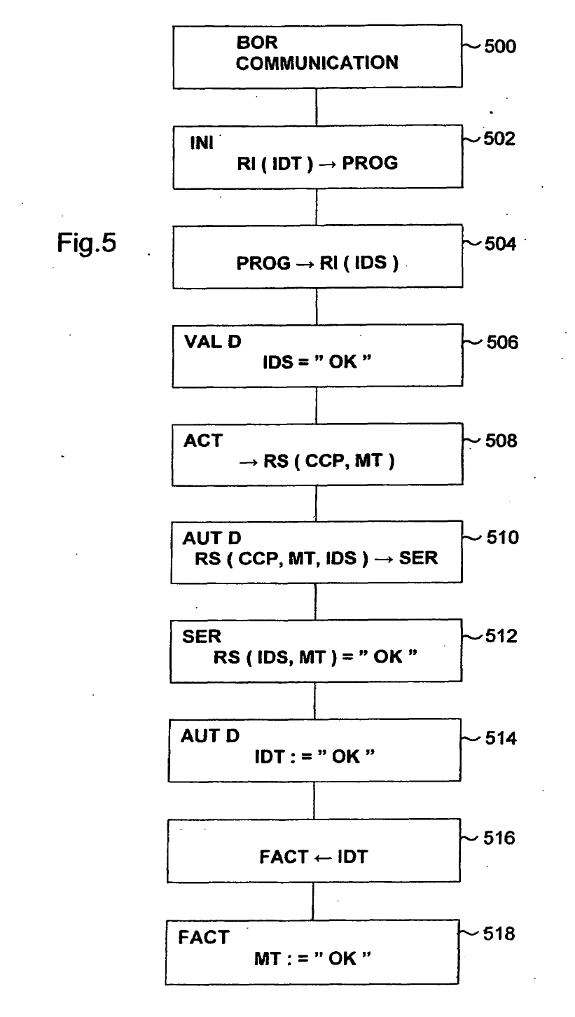

FIG. 5 is a flow-chart illustrating the function of the device of FIG. 4 according to an advantageous method of use.

The drawings and attachments contain essentially elements of a specific nature. They may therefore be used not only to aid understanding of the description, but also contribute to its definition if necessary.

FIGS. 1A, 1B and 1C show in a schematic manner the device according to the invention in a first embodiment.

The device according to the invention incorporates an automatic cash dispenser 2, which conventionally comprises a card reader 4 capable of reading data contained in the chip of an access card 6, in particular a confidential access code CCA known to the owner and a bank identifier IDB designating a particular bank account. Furthermore, the automatic cash dispenser 2 comprises a calculator 8 capable of applying a system of use (not shown), which is contrived to interact with the various elements contained in the automatic cash dispenser 2.

The calculator 8 is contrived to react to the insertion of the access card 6 into the card reader 4 by executing a transaction program 12. The transaction program 12 launches a validation function 14, which determines the validity of the access card 6 from data contained in the chip and transmitted by the card reader 4. If the access card 6 is deemed to be valid, the transaction program 12 calls a verification function 16, which compares the confidential access code CCA contained in the chip of the access card 6 to a code CS captured by the user by means of an access terminal 18 incorporated in the automatic cash dispenser 2 and capable of interacting with the calculator 8. If the code captured CS is identical to the confidential access code CCA, the transaction program 12 calls up a data function 20, which interacts with the access terminal 18 to ask then learn from the user the amount MT of a sum of money to be issued. The transaction program 12 then launches an authorisation function 22, which transmits a transaction request RDT to a remote authorisation server 24 connected to the automatic cash dispenser 2 according to means known to the person skilled in the art. The transaction request is formed of the bank identifier IDB contained in the chip of the access card 6 and obtained by the card reader 4, and of the amount to be issued MT. The transaction request RDT is authorised by the remote authorisation server 24 if the credit of the bank account designated by the bank identifier IDB is sufficient, taking into account the amount to be issued MT. If the transaction request RDT is authorised by the remote authorisation server 24, the transaction program 12 calls an issuing function 26, which interacts with a banknote issuer 28 in order to supply the amount to be issued.

The flow-chart of FIG. 2 summarises the various operations carried out by the functions of the transaction program 12. At the operation 200, the calculator 8 launches the transaction program 12 upon insertion of the access card 6, then, at the operation 202, the validation function 14 tests the validity of the access card 6 according to data contained in the chip. If the access card 6 is not or is no longer valid, a cancellation function not shown in FIG. 1B ends the transaction program 12 and cooperates with the card reader 4 to return the access card 6 at the operation 204. If the access card 6 is valid, at operation 206, the verification function evaluates whether the code captured CS by the user is identical to the confidential access code CCA read on the access card 6. If not, the operation 204 of cancelling the transaction and returning the card is launched. If the code captured CS and the confidential access code CCA are identical, the information function 20 asks and learns the amount to be issued MT during the operation 208, then the authorisation function 22 transmits to the remote authorisation server 24 the transaction request RDT at operation 210. If the transaction request RDT is accepted (operation 212), the issuing function 26, at operation 214, issues the banknotes. If not, at operation 204, the cancellation function is called, which ends the transaction program 12 in the manner described above.

The flow-chart of FIG. 2 shows that the automatic cash dispenser 2 is occupied by the user throughout operations 200 to 214 whereas the physical presence of the user is not absolutely required until operation 214, i.e. when the banknotes are being issued. The time of occupation of the automatic cash dispenser is thus much longer than the time actually necessary for the issue of the banknotes. When plural users are capable of using the automatic cash dispenser 2 one after another, the time needed to process the transactions of all the users is particularly long compared to the time really necessary to issue the banknotes.

The operation 214 can be designated as a transaction and the operations 200 to 212 as being the preparation for the transaction.

In this embodiment, the device according to the invention has the purpose of allowing execution of the preparation for the transaction without the physical presence of the user in front of the automatic cash dispenser 2.

In this embodiment of the device according to the invention, illustrated in FIGS. 1A, 1B and 1C, the automatic cash dispenser 2 is connected to a short-range radio communication terminal 32 via a known wired link. The terminal 32 is capable of setting up a communication in the form of radio waves with a mobile terminal 34 located inside a perimeter 36, which is defined at least in part by the terminal 32 and possibly by means of plural other similar terminals not shown.

Advantageously, the terminal 32 conforms to WiFi and/or Bluetooth communication standards and the mobile terminal 34 is a mobile telephone of the GPRS or GSM type further having a short-range communication device 33 adapted to the terminal 32, e.g. in the form of a Bluetooth or WiFi unit. The mobile terminal 34 may also be a personal digital assistant (designated generally by the term PDA) incorporating a communication unit to the Bluetooth or WiFi standard. In both cases, other communication standards are usable. For example, the communication device 33 may take the form of a unit operating according to NFC technology (short-range wireless communication technology).

Obviously, the terminal 32 can be arranged to operate according to any other wireless communication standard, in particular short-range radio. The mobile terminal 34 may also take the form of any communication apparatus conforming to a mobile cell network communication technology.

The automatic cash dispenser 2 also comprises a virtual automaton program 36 as well as a cash management program 38, both executed by the calculator 8. The virtual automaton program is capable of interacting with the terminal 32 by means of a request transmission function 40 and by a request receiving function 42 for transmitting and receiving requests with the mobile terminal 34.

The mobile terminal 34 conventionally comprises means of memorisation and calculating, not shown, contrived respectively to save and execute a program 44, which may be subject to a bank subscription, capable of interacting with the short-range radio communication device 33. The memorisation means may also contain a service identifier IDS capable of identifying uniquely the mobile terminal 34 and the bank coordinates of its owner.

When the mobile terminal 34 is located within the perimeter 36, it can set up a communication between the mobile terminal 34 and the terminal 32 associated with the automatic cash dispenser 2 according to a method known to the person skilled in the art (operation 300). The communication between the mobile terminal 34 and the terminal 32 may be initiated spontaneously by mutual recognition of the mobile terminal 34 and of the terminal 32 or may result from a voluntary action, e.g. by means of a request transmitted by the user of the mobile terminal 34.

The communication between the mobile terminal 34 and the automatic cash dispenser 2 supports an initiation request RI transmitted by the virtual automaton program 36 by means of the request transmission function 40 and created by an initiation function 43 at operation 302. The initiation request RI comprises a transaction identifier IDT generated upon transmission. The program 44 processes the initiation request RI by returning the value of the service identifier IDS at operation 304. Upon receiving the response to the initiation request RI, the virtual automaton program 36 calls a remote validation function 50, which determines the validity of the service identifier IDS during operation 306. If the service identifier IDS is deemed to be valid, the virtual automaton program 36 is put on hold.

The bank subscription program 44 further comprises an activation function 52 capable of transmitting, during the operation 308, a remote transaction request RTD in the direction of the automatic cash dispenser 2 indicating the amount of money to be issued MT as well as the value of a confidential personal code CCP, which is associated with the service identifier IDS.

According to a first configuration of the invention, the confidential personal code CCP is recorded in the memory of the mobile terminal 34, with which the activation function 52 is capable of interacting to read then transmit the value of the said code. In an alternative configuration, the confidential personal code CCP is known by the user, who captures the code via a digital keypad not shown to allow its transmission by the activation function 52. In yet another configuration, the remote transaction request RTD does not contain the value of the confidential personal code CCP but an equivalent code whose transmission is a subject to the verification of a security criterion linked to the service: e.g., the verification of a digital imprint of the user before the transmission of the remote transaction request RTD by means of a device known to the person skilled in the art.

In a particular embodiment, the activation function 52 transmits a remote transaction request RTD comprising a predetermined amount MT upon the single pressing of a mobile terminal key. In a modification of this particular embodiment, different keys are associated with the transmission of remote transaction requests RTD indicating different predetermined amounts MT.

In one configuration of the invention, upon receiving the remote transaction request RTD, the virtual automaton 36 interacts with the verification function 16, which verifies agreement between the service identifier IDS and the confidential personal code CCP. If the confidential personal code CCP corresponds to the service identifier IDS, the virtual automaton program 36 proceeds to process the remote transaction request RTD by calling a remote authorisation function 54, similar to the authorisation function 22 described above, which transmits a transaction request RDT to the remote authorisation server 24 comprising inter alia the service identifier IDS and the amount MT (operation 310) following a process similar to that described above.

In another configuration of the invention, upon receiving the remote transaction request RTD, the virtual automaton program 36 transmits the transaction request RDT to the remote authorisation server 24 without verifying agreement between the confidential personal code CCP and the service identifier IDS. In this embodiment, the transaction request RDT further comprises the value of the confidential personal code CCP and the service identifier IDS. The remote authorisation server 24 is contrived to verify agreement between the confidential personal code CCP and the service identifier IDS, and to validate the transaction request RDT in the affirmative.

In one configuration of the invention, the mobile terminal 34 further comprises a verification function, similar to the verification function 16, executed in a memory of the mobile terminal 34 and verifying the agreement between the confidential personal code CCP and the service identifier IDS. In the affirmative, the activation function 52 transmits the remote transaction request RTD, which in this configuration does not comprise the value of the confidential personal code CCP.

In a particular configuration of the invention, no confidential personal code CCP is associated with the service identifier IDS, so that the identity of the user of the mobile terminal 34 cannot be verified according to one of the means described above. In this case, the identification capacity particular to the mobile terminal, e.g. the SIM card, may be used.

In all the configurations described above, if the transaction request RDT is validated by the remote authorisation server 24 (operation 312), the virtual automaton program 36 responds to the remote transaction request RTD by means of the remote authorisation function 54, which associates the “validated” value to the transaction identifier IDT (operation 314).

The calculator 8 of the automatic cash dispenser 2 is further contrived to carry out a monitor program 55, which comprises a data table (not shown) associating with each transaction identifier IDT a state indicator IDE which may take one of the “validated” or “non-validated” values and a timer TMR capable of counting the time elapsed since validation of the transaction.

When the value of the timer associated with a transaction identifier IDT exceeds a predefined value, the monitor 55 associates the “non-validated” value to the state indicator of the transaction.

The virtual automaton program 36 is contrived to respond to the presentation of the transaction identifier IDT, according to a process described below, by calling a repeat function 53 (operation 316), which is capable of interrogating the monitor program 55 in order to verify the existence of the transaction identifier IDT in the table mentioned above.

According to one configuration of the invention, the virtual automaton programme is contrived to interact with the terminal 18, which is used by the user to capture the transaction identifier IDT.

In another configuration, the virtual automaton program 36 interacts with the receiving function 42, which receives the value of the transaction identifier IDT of the mobile terminal 34 via the terminal 32. According to a first application, the transaction identifier IDT has been brought to the attention of the user, e.g. by means of a display element of the mobile terminal 34 (not shown), then captured by the user and transmitted by the program 44. According to a second application, the transaction identifier IDT is memorised in a memory of the mobile terminal 34 and transmitted by the program 44 upon an action by the user.

In yet a further configuration, the virtual automaton program 36 comprises means of reading the value of the transaction identifier IDT contained in a memory of the mobile terminal 34. This configuration is privileged in the case where the remote transaction request RTD has been transmitted upon pressing a single key of the mobile terminal 34 with a predetermined amount MT.

In yet a further configuration, the transaction identifier IDT comprises information designating one of the keys on the automatic cash dispenser. The program 44 is capable of prompting the display of this information on the screen of the mobile terminal 34. The virtual automaton program 36 maintains correspondence between the information designating the key and the transaction identifier IDT in such a manner that when the designated key is actuated, the virtual automaton program 36 recovers the transaction identifier IDT so as to complete the transaction. This latter configuration offers both good speed of execution of the transaction and good security since the mobile terminal 34 can be kept for example in the pocket of the user. Obviously, when plural transactions are initiated from one mobile terminal 34, different keys are associated with different transaction identifiers IDT.

In the case where the transaction identifier IDT is present in the table of the monitor program 55, and if the state indicator IDE associated with the transaction identifier IDT has the “validated” value, the cash management program 38 interacts, according to one configuration, with the cash issuer 28 in order to issue the amount MT (operation 318). Otherwise, the cash management program 38 ends without commanding the issue of cash. Optionally, before the issue of the cash, the virtual automaton program 36 calls a comparison function 60, which compares the value of the transaction identifier IDT present in the table with the value of the transaction identifier IDT read in the memory of the mobile terminal 34. The issue of cash only takes place if the two values agree.

Advantageously, the radio communications between the terminal 32 and the mobile terminal 34 are encrypted according to a method known to the person skilled in the art.

The flow-chart of FIG. 3 shows that the physical presence of the user is only necessary for the operations 316 and 318. Only the presence of the user within a close perimeter is required during initiation of the preparation for the transaction.

By virtue of the device according to the invention, the occupation time of the automatic cash dispenser 2 by a user is reduced. This has two advantages. On the one hand, since the time spent in front of the automatic cash dispenser 2 is reduced, the risk of attack, e.g. theft of the access card 6 or of the cash, is reduced. On the other hand, the automatic cash dispenser 2 can handle more user transactions within a given time.

It is important to note that the automatic cash dispenser 2 described above may be simplified. In a particular embodiment, in fact, the automatic cash dispenser 2 comprises only the virtual automaton program 36 with all the functions described above, as well as the monitor 55, the cash manager 38 and the cash issuer 28. In this embodiment, the transaction program 12, the reader 4 and the terminal 18 do not exist, which makes it possible to reduce considerably the bulk of the automatic cash dispenser 2 as well as its complexity. In this embodiment, the verification of agreement between the confidential personal code CCP and the service identifier IDS is effected by the remote server 24 by means of a request in a manner similar to that described above, and the presentation of the transaction identifier IDT is effected by the mobile terminal 34. Alternatively, verification of agreement between the confidential personal code CCP and the service identifier IDS can be effected by a function incorporated in the virtual automaton program 36. Thus, in particular, it is possible to do without the verification function 16 and the terminal 18. It is therefore particularly advantageous to provide in the cash dispenser a device capable of interacting with the cash issuer 28 in order to prepare the amount MT to be issued directly upon validation of the transaction by the remote server 24, which makes it possible to reduce by that amount the time required for the physical presence of the user in front of the automatic cash dispenser 2.

In certain applications, the physical presence of a credit card at the automatic cash dispenser 2 may be deemed essential. In this case, the invention makes it possible to limit the interaction of the user with the dispenser 2 to the insertion of the credit card therein. The features of the credit card have then already been verified upon preparation for the transaction. If necessary, the verification of the identity of the credit card holder can be carried out by keying in a confidential code (PIN code); this verification may also have already been done in advance, e.g. by presenting in advance the confidential code via the mobile terminal 34 consequently securitised. Following this securitisation, the confidential code in question may be keyed in to the keypad of the mobile terminal 34 or else stored and sent upon the user's instructions defined by an action or combination of actions, e.g. pressing on a key of the mobile terminal 34. In the same way, also according to the securitisation, all or some of the features of the credit card can be stored in the mobile terminal 34.

Whereas the preparation of a cash withdrawal when carried out in front of the automatic cash dispenser 2 is particularly traceable and identifiable, nothing makes it possible to discern this preparation when it is carried out by means of the mobile terminal 34 by virtue of the device according to the invention. This accordingly reduces the risks of attack.

In a different embodiment, shown in FIGS. 4 and 5, the device according to the invention is applied in a shop and comprises a check-out terminal 70, which incorporates a calculator for carrying out a solvency program 64.

The check-out terminal 70 is connected, as described above, to the terminal 32 capable of reacting to the presence of the mobile terminal 34 within the perimeter 36 defined at least partly by the terminal 32, as is described above, by setting up a communication (operation 500) between the mobile terminal 34 and the check-out terminal 70. The discovery of the mobile terminal 34 may take place, in one embodiment, implicitly upon the initiative of the terminal 32. In another embodiment, the mobile terminal 34 comprises a discovery function (not shown) capable of signalling the presence of the mobile terminal 34 to the terminal 32 in an explicit manner.

Upon setting up of the communication, the solvency program calls the initiation function 43, which transmits the initiation request RI allowing the exchange of the service identifier IDS against the transaction identifier IDT according to the process described above (operations 502 and 504). Upon reception of the response to the initiation request RI, the solvency verification program 64 determines the validity of the service identifier IDS by means of the remote validation function 50 (operation 506).

The solvency program 64 is placed on hold for receiving a solvency request RS transmitted by the activation function 52 of the mobile terminal 34 and containing on the one hand the amount MT of an authorisation to be issued, and on the other hand the confidential personal code CCP (operation 508). As was mentioned above, the confidential personal code CCP may be memorised in the mobile terminal 34 or again captured by the user.

The response to the initiation request RI may take place after validation of a function by the user or be transparent to the latter.

Upon receiving the solvency request RS, the solvency program 64 interacts with communication means connecting the check-out terminal 70 to the remote authorisation server 24 in order to transmit a solvency request RS containing the amount MT, the service identifier IDS and the confidential personal code (operation 510).

According to an optional feature of the invention, the solvency program 34 comprises a digital table TS (not shown) associating the service identifier IDS with an authorised amount MTA. The solvency program 64 then reacts to the solvency request RS by interrogating the digital table TS: if the amount MT contained in the solvency request RS is lower than the authorised amount MTA, the transaction is authorised without calling the remote authorisation server 24. In the opposite case, the solvency program 64 transmits a solvency request RS to the remote server 24 according to the method described above.

If the bank account designated by the service identifier IDS is sufficiently in credit, the response (operation 512) to the solvency request RS is positive and the solvency program 64 calls the remote authorisation function 54, which associates the “validated” value to the transaction identifier IDT at operation 514.

When the user arrives in front of the check-out terminal 70 in order to pay for his purchases, the calculator 62 executes the invoicing program 66, which starts by establishing the sum of the purchases. The invoicing program 66 reacts to the capture of the transaction identifier IDT by the user by interrogating the monitor program 55 according to the process described above.

If the state identifier associated with the transaction identifier IDT is at the “validated” value, and the amount calculated of the purchases is lower than the amount MT, the user can leave with his purchases while a conventional banking operation will debit the account identified by the service identifier IDS.

In the opposite case, i.e. if the state indicator associated with the transaction identifier IDT is at the “non-validated” value, or if the sum of purchases is higher than the amount MT, the payment is carried out in a conventional manner.

By virtue of the device according to the invention, the user can, while making his purchases, have the solvency request prepared for the estimated amount of his purchases. Individually, he saves time at the moment when he moves to the check-out. Overall, the use of the device according to the invention by a larger number of clients reduces the waiting time of each client at the check-out. The device according to the invention thus makes solvency checks easier.

In both embodiments of the device according to the invention described above, the perimeter 36 defines a zone in which the preparation of the transaction is possible. The perimeter 36 may be adapted, by virtue of a device known to the person skilled in the art, by reducing the range of the terminal 32 or of the entirety of terminals used for defining the zone. Consequently, it is possible to adapt the perimeter 36 (i.e. the range of the terminal) and the localisation of the terminal 32 so as to cover the zone desired. For example, in the second embodiment, it is advantageous that the zone defined by the terminal 32 and the perimeter 36 covers as exactly as possible the area of the shop.

In the two embodiments described above, the monitor program 55 can understand options allowing allocation of the “non-validated” value of the transaction identifier in the following cases:
if the mobile terminal 34 leaves the perimeter 36 without validation of the transaction,
if the mobile terminal 34 leaves the perimeter 36 for a predetermined time,
if there is a cancellation message transmitted from the mobile terminal 34.

The two embodiments described above are only examples of applications of the invention. The invention is applicable to any transaction device having a preparatory phase of the transaction for which the physical presence of the user in front of the service delivery element is not absolutely required. Preparatory phases have been described for transactions comprising a solvency verification stage, but the invention can be applied in other cases.

Thus it is conceivable to apply the invention in a fast-food-type restaurant. In this case, the mobile terminal 34 interacts with an order program executed in the memory of a check-out, or of a check-out network, in order to establish the user order in exchange for a transaction identifier IDT. The order will be issued to the user upon his arrival at the check-out upon presentation of the transaction identifier.

The invention can also be applied in a cinema. The user at the approach to the cinema transmits a request to a reservation program recorded and executed in a memory of a check-out or check-out network of the cinema specifying the viewing in exchange for a transaction identifier IDT. Upon presentation of the transaction identifier, the ticket is issued to the user.

The invention can also be incorporated in an access control device, some of the verifications of which connected to the identity, for example, can be pre-processed. Once the verifications have been completed, a simple code is made known to the user of the mobile terminal. The presentation of this code to a control station validates access.

The various embodiments described above have three things in common:
a preparation for the transaction, or pre-processing carried out initially by means of a mobile terminal such as a telephone or the like;
the fact that at the site of execution of the transaction, i.e. at the “station”, which is for example a cash dispenser or a check-out, a transaction thus prepared is used so as to simplify and streamline as much as possible, and within the confines of the desired security, the terminal exchanges between the client and the trader, whether this be the bank in the case of an automatic cash dispenser or a conventional trader in the case of a check-out; and
the presence of the user within a perimeter close to the station.

The present application shows the advantage of using a mobile terminal such as a telephone within the scope of such a transaction preparation.

The notion of the mobile terminal is not limited to a mobile telephone or a PDA-type personal assistant, but extends to any data support having short-range communication capacity.

In the above, the arrangements taught by the invention are, for their digital part, essentially placed in the assembly constituted by a wireless apparatus and the transaction station.

However, in another approach, the present invention can be viewed directly, in a case where one might seek to transfer the arrangements to a remote server having responsibility for carrying out all or some of the “pre-processing” tasks or preparation for the transaction.

In this case, the initial contact carried out by means of the mobile terminal may consist in calling by conventional telephone the processing centre in question. This then undertakes by using the telephone connection—requiring the identification characteristics permitted by the mobile telephone, and one or more personal identification codes—to carry out the parts of pre-processing which comprise personal identification, the definition of bank details, and possibly that of an amount of credit.

The server will also be able to transmit pre-processing data, or the part which will have been carried out by this server, to the associated apparatus at the transaction station, or even the transaction station itself. The identification of the transaction station (or of the system of which it forms part) upon the initial communication can then be carried out by an appropriate code, or even by the telephone number to be dialled.

In this case, the local radio circuit can be used with its “perimeter”, for an automatic transmission of these data (telephone number and/or code) to the mobile terminal. In the case of a mobile terminal which would not be capable of radio communication, this information can even be transmitted by visual, audio or any other means.

In the development of the paragraphs above, the essential element of the invention is therefore the use of a transaction station at least partially prepared in advance, on the same bases as described above. From this point of view, it is possible to carry out the preparation of the transaction by numerous different means, linked to a mobile terminal or not.

The pre-processing can be applied in various ways, in cases where a service only has a limited physical reception capacity in order to satisfy the user or client (who will then be kept waiting). It is possible to cite applications of ticket-issuing (bus, train, cinema etc.), administrative services (pre-processing of the file, or the verification of data concerning the holder of an electronic passport or the passport itself, which is for example allocated a radiofrequency tag (also known as RFID tag), service stations (invoicing)).

Automatic dispensers of films can also benefit advantageously from the pre-processing system according to the invention. In fact, the users often spend a relatively long time to carry out the selection of the desired film: the film initially desired may be unavailable, consultation of information about the film (jacket, summary, main actors) and/or reading through the list of films on offer takes up time.

The invention therefore makes it possible to avoid taking up the automatic film dispenser for this selection phase and the fact of having to set up additional selection terminals attached to the automatic film dispenser in order to cope with busy periods. The users equipped with a mobile terminal and present within the perimeter surrounding the automatic film dispenser can carry out the selection by means of their mobile terminal and even benefit from the multimedia functions offered by modern mobile terminals, e.g. to view film trailers. Only the actual collection of the film requires the user to have physical access to the dispenser.

Finally, it is obvious that one mobile terminal can be used to initiate different transactions either with the same service delivery station (cash dispenser, check-out terminal etc.) or with stations dedicated to different services.

The definition of the perimeter associated with the terminal may involve localisation technology and/or guiding by satellite, also known by the technical term GPS. In this case, the mobile terminal has GPS functions, e.g. by virtue of a particular module. The presence of a user within a given perimeter can then be established by means of data on the position of the user communicated by GPS. The user can also receive data about the position of the terminal via the GPS unit.

The invention is not limited to the embodiments described above, solely by way of example, but encompasses any modifications which are conceivable to the person skilled in the art.

1. Transaction device comprising:
a station capable of carrying out a transaction; and
an apparatus capable of setting up a wireless communication network with one or more mobile terminals, based on a connection protocol, as well as a communication with the station,
wherein the apparatus is configured with a perimeter selected to cover a determined zone, close to the station,
wherein the connection protocol is configured to allow the initial exchange of an identity information (IDS) transmitted by a mobile terminal present in the zone against a unique temporary code (IDT), such exchange being followed by the launch of a background function allowing the preparation of at least part of a transaction on the basis of the identity information (IDS), and
wherein the station is capable, upon presentation of the unique temporary code (IDT), of recovering, then completing as required, and validating the transaction.

2. Transaction device according to claim 1, wherein the station is configured to form part of a wireless communication network of the said apparatus.

4. Transaction device according to claim 1, wherein the apparatus is configured to operate according to a short-range radio communication standard.

5. Transaction device according to claim 1, wherein the apparatus is configured to operate according to the Bluetooth or NFC standard.

6. Transaction device according to claim 1, wherein the background function is launched upon receipt of a message or through the communication apparatus.

7. Transaction device according to claim 1, wherein the background function is implanted at least in part in the station or in a local network of which the station forms part.

8. Transaction device according to claim 1, wherein the background function is implanted at least in part in the apparatus.

9. Transaction device according to claim 1, further comprising a communication unit capable of allowing a communication with a remote server, and in that the preparation of transaction comprises at least one verification linked to the said identity information (IDS), and carried out by interrogation of the remote server.

10. Transaction device according to claim 9, wherein the non-prepared part of the transaction comprises a financial element, and wherein the interrogation of the remote server comprises a credit verification linked to the identity information (IDS).

11. Transaction device according to claim 10, wherein the interrogation of the remote server comprises a credit verification for an amount linked at least in part to a class of transactions carried out by the station and to the identity information (IDS).

12. Transaction device according to claim 9, wherein the interrogation of the remote server comprises a credit verification for an amount defined by complementary data established during the initial exchange.

13. Transaction device according to claim 10, wherein the transaction comprises a cash withdrawal.

14. Transaction device according to claim 10, wherein the transaction is a commercial transaction.

15. Transaction device according to claim 10, wherein the transaction is of the access control type.

16. Transaction device according to claim 10, wherein the presentation of the unique temporary code (IDT) to the station is carried out from the mobile terminal.

17. Transaction device according to claim 10, wherein the station comprises a verification function capable of comparing the value of the unique temporary code (IDT) presented with a value of the reference unique temporary code (IDT) and whose result is a condition of validation of the transaction.

18. Transaction device according to claim 17, wherein the station further comprises an interrogation function configured to set up as the value of the reference unique temporary code (IDT) a value of the unique temporary code (IDT) recorded in a memory of the mobile terminal.

19. Transaction device according to claim 18, wherein the station comprises a capture element for presentation of the unique temporary code (IDT).

20. Transaction device according to claim 17, wherein the value of the reference unique temporary code (IDT) is transmitted by the mobile terminal.

21. Transaction device according to claim 10, wherein presentation of the unique temporary code (IDT) to the station is carried out from the mobile terminal through the same wireless communication network.

22. Transaction device according to claim 10, further comprising a monitor function capable of cancelling a transaction prepared according to a selected expiry criterion.

23. Transaction device according to claim 2, wherein the apparatus is configured to operate according to a short-range radio communication standard.

24. Transaction device according to claim 10, wherein the interrogation of the remote server comprises a credit verification for an amount defined by complementary data established during the initial exchange.
